(19) United States
(12) Patent Application Publication
(10) Pub. No.: US 2008/0259482 A1
(43) Pub. Date: Oct. 23, 2008

(54) Fabrication of discrete track media for narrow groove and improved reliability

(75) Inventors: Kiseok Moon, Pleasanton, CA (US); Soo Youl Hong, Santa Clara, CA (US); Yawshing Tang, Saratoga, CA (US); Xiaodong Che, Saratoga, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/788,630

(22) Filed: Apr. 20, 2007

(51) Int. Cl. G11B 5/02; G11B 5/127; B05D 5/12; G11B 5/82

(52) U.S. Cl. 360/55; 977/932; 427/127; 360/135

(57) ABSTRACT

A magnetic media that has at least one groove. The groove is created by a process that includes initially forming a temporary layer over a magnetic layer of the disk. One or more grooves are formed in the temporary and magnetic layers. The temporary layer is removed and a protective layer is formed over the magnetic layer and within the groove.

### BACKGROUND OF THE INVENTION

1. Field of the Invention

The present invention relates to magnetic media used in hard disk drives.

2. Background Information

Hard disk drives contain a plurality of magnetic heads that are coupled to rotating disks. The heads can magnetize and sense the magnetic fields of the disks to write and read data, respectively. The heads each have an air bearing surface that cooperates with a flow of air generated by the rotating disks to create an air bearing. The air bearing prevents mechanical wear between the head and the disk.

Data is stored on concentric tracks that extend across the surfaces of the disks. Each track is typically segmented into sectors that each have one or more data fields.

The heads magnetize the disk in either a horizontal direction parallel with the disk surface, of a vertical direction perpendicular to the surface of the disk. Vertical recording occupies less surface space and thus allows for increased disk capacity.

Residual magnetism within the disk creates noise between adjacent tracks. This noise can be reduced by creating micro-grooves in the surfaces of the disks. The grooves are located between the disk tracks. The grooves extend through the magnetic layer of the disk to inhibit any magnetic coupling between the adjacent tracks.

The grooves can be formed after the layers of the disks have been fabricated. Increases in track density require smaller groove widths. The disks are typically covered with a protective layer of hard carbon. Forming smaller grooves through hard carbon can be a difficult process. In general it is more difficult to form grooves as the depth to width ratio of the groove increases. Additionally, the grooves expose the underlying material creating corrosion issues for the disk. It would be desirable to provide a process that allows for the formation of relatively small grooves and which does not result in exposed underlying disk material.

### BRIEF SUMMARY OF THE INVENTION

A method for fabricating a magnetic media of a hard disk drive. The method includes providing a media that includes a magnetic layer and a substrate. A temporary layer is formed on the magnetic layer. At least one groove is formed in the temporary and magnetic layers. The temporary layer is removed and a protective layer is formed over the magnetic layer and into the groove.

### BRIEF DESCRIPTION OF THE DRAWINGS

FIG. 1 is a top view of a hard disk drive;

FIG. 2 is an illustration showing a section of a magnetic media;

FIG. 3 is an illustration similar to FIG. 2 showing grooves formed in the media;

FIG. 4 is an illustration similar to FIG. 3 showing a layer of protective material added to the magnetic media.

FIG. 5 is a graph showing variations in magnetic properties as a function of the thickness of a magnetic layer.

### DETAILED DESCRIPTION

Disclosed is a magnetic media that has at least one groove. The groove is created by a process that includes initially forming a temporary layer over a magnetic layer of the disk. One or more grooves are formed in the temporary and magnetic layers. The temporary layer is removed and a protective layer is formed over the magnetic layer and within the groove.

The process does not require cutting through the protective layer which allows for more narrow grooves. Additionally, adding the outer protective layer after the formation of the grooves insures that all of the disk material, including the grooves, is protected by the outer layer.

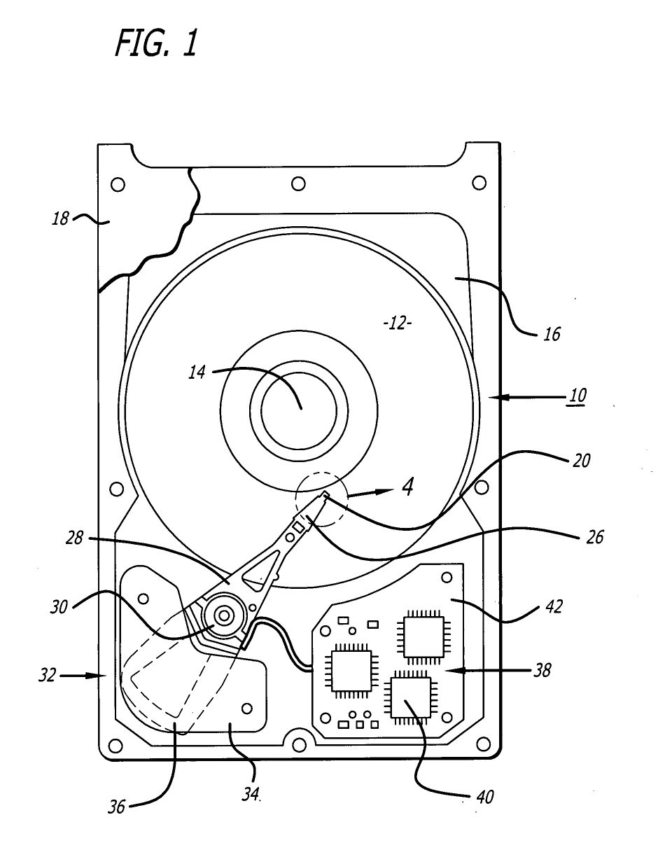

Referring to the drawings more particularly by reference numbers, FIG. 1 shows an embodiment of a hard disk drive 10. The disk drive 10 may include one or more magnetic disks 12 that are rotated by a spindle motor 14. The disks 10 are also referred to as magnetic media. The spindle motor 14 may be mounted to a base plate 16. The disk drive 10 may further have a cover 18 that encloses the disks 12. The disk has a plurality of micro-grooves 19 located between adjacent disk tracks.

The disk drive 10 may include a plurality of heads 20 located adjacent to the disks 12. Each head 20 may have separate write (not shown) and read elements (not shown). The heads 20 are preferably of the type that magnetize the disks in a direction perpendicular to the disk surfaces. Such heads are typically referred to as vertical or perpendicular recording heads.

The heads 20 are gimbal mounted to a corresponding flexure arm 22. The flexure arms 22 are attached to an actuator arm 24 that is pivotally mounted to the base plate 16 by a bearing assembly 26. A voice coil 32 is attached to the actuator arm 24. The voice coil 32 is coupled to a magnet assembly 34 to create a voice coil motor (VCM) 36. Providing a current to the voice coil 32 will create a torque that swings the actuator arm 24 and moves the heads 20 across the disks 12. The actuator arm 24 and flexure arms 22 can collectively be referred to as an actuator arm assembly.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14. The cover 18 and base plate 16 enclose the disk 12 and heads 20 of the disk drive 10. The printed circuit board assembly 38 may include a controller that controls the operation of the disk drive

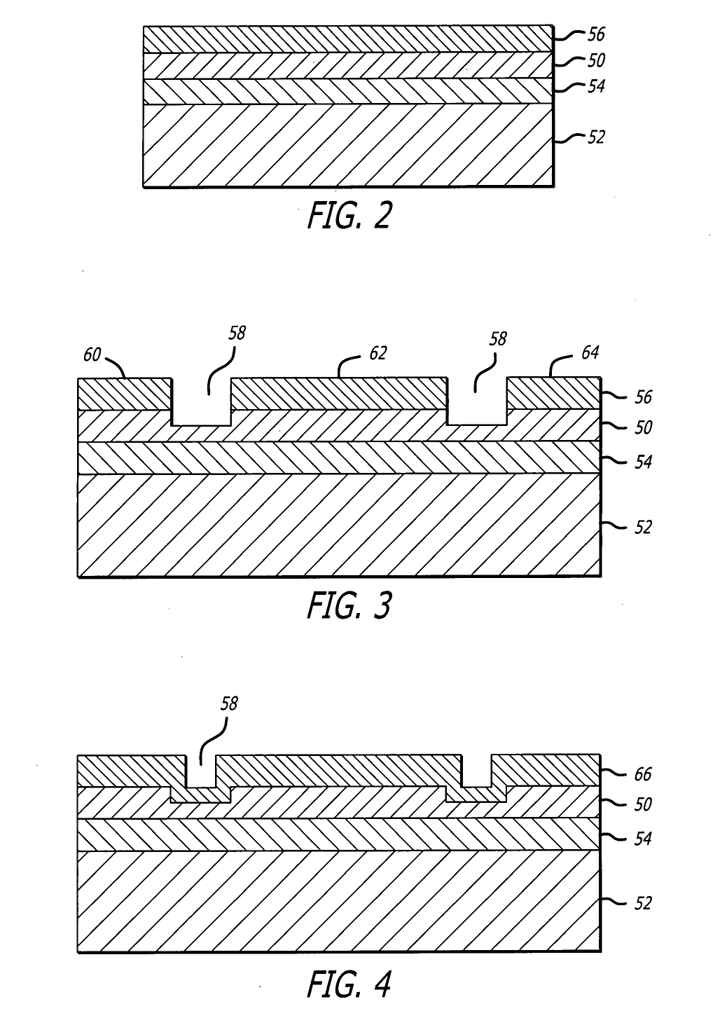

FIGS. 2, 3 and 4 show a process for fabricating the disk 10. The process includes providing a media that includes a magnetic layer 50 supported by a substrate 52. The media may include a intermediate layer 54 to enhance adhesion of the magnetic layer 50 to the substrate 52. A temporary layer 56 is formed on the magnetic layer 50. By way of example, the temporary layer 56 may be AL or ALN material.

As shown in FIG. 3 grooves 58 may be formed in the temporary 54 and magnetic 50 layers. By way of example, the grooves 58 may be formed with an electron beam or nano-imprinting process. The grooves 58 are formed at locations between adjacent tracks 60, 62 and 64. The formation of the grooves 58 remove magnetic material that may induce magnetic cross-talk and noise between adjacent tracks 60 and 62, and 62 and 64.

The grooves 58 preferably do not extend all the way through the magnetic layer 50. Reducing the groove depth allows the grooves 58 to made more narrow without increasing the depth to width ratio, a limiting factor in groove formation. By way of example, the grooves 58 may extend through approximately one-half the thickness of the magnetic layer 50.

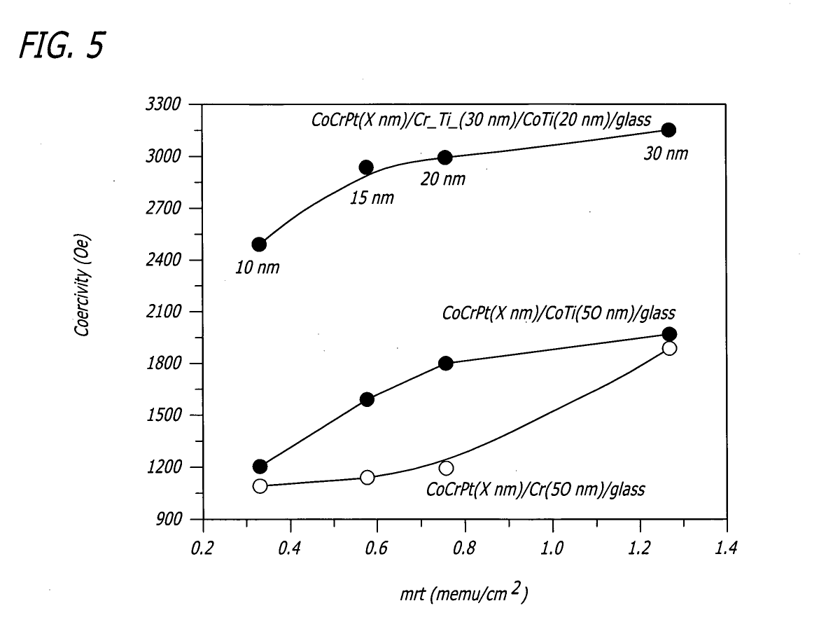

As shown in FIG. 5 the magnetic properties of coercivity and Mr have a reduction with a magnetic layer thickness at about 20 nanometers. Consequently, the grooves 58 can be formed so that the magnetic layer thickness is no greater than 20 nanometers. Such a structure still minimizes magnetic cross-talk and noise between adjacent tracks.

As shown in FIG. 4, after the grooves 58 are formed the temporary layer 54 can be removed and a protective layer 66 can be formed on the magnetic layer 50. The protective layer 66 also covers the grooves 58. By way of example, the protective cover 66 may be a diamond-like-material. A layer of lubricant (not shown) can be formed onto the protective layer 66.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, if the magnetic layer 50 is a composite material the grooves 58 can be formed into the composite material to a depth where residual magnetism is essentially zero.

What is claimed is:

1. A method for fabricating a magnetic media of a hard disk drive, comprising:
providing a media that has a magnetic layer and a substrate;
forming a temporary layer over the magnetic layer;
forming a least one groove in the temporary and magnetic layers;
removing the temporary layer; and,
forming a protective layer over the magnetic layer and into the groove.

2. The method of claim 1, wherein the groove does not extend through the entire magnetic layer.

3. The method of claim 1, wherein the groove is formed with a milling process.

4. The method of claim 1, wherein a thickness of magnetic layer in the groove is no greater than 20 nanometers.

5. The method of claim 1, wherein the groove has a depth within the magnetic layer that is approximately one-half the thickness of the magnetic layer.

6. A magnetic media of a hard disk drive, comprising:
a substrate;
a magnetic layer adjacent to the substrate, said magnetic layer having at least one groove with a depth that does not extends through said entire magnetic layer; and,
a protective layer that covers said magnetic layer and said groove.

7. The media of claim 6, wherein a thickness of said magnetic layer in said groove is no greater than 20 nanometers.

8. The media of claim 6, wherein said groove has a depth within said magnetic layer that is approximately one-half the thickness of said magnetic layer.

9. A hard disk drive, comprising:
a base plate;
a spindle motor coupled to said base plate;
a disk coupled to said spindle motor, said disk including;
a substrate;
a magnetic layer adjacent to the substrate, said magnetic layer having at least one groove with a depth that does not extends through said entire magnetic layer;
a protective layer that covers said magnetic layer and said groove;
an actuator arm coupled to said base plate;
a voice coil motor coupled to said actuator arm; and,
a perpendicular recording head structurally coupled to said actuator arm and magnetically coupled to said disk.

10. The disk drive of claim 9, wherein a thickness of said magnetic layer in said groove is no greater than 20 nanometers.

11. The disk drive of claim 9, wherein said groove has a depth within said magnetic layer that is approximately one-half the thickness of said magnetic layer.
